(19) United States
(12) Patent Application Publication
(10) Pub. No.: US 2010/0182987 A1
(43) Pub. Date: Jul. 22, 2010

(54) METHOD AND APPARATUS FOR TRANSMITTING/RECEIVING DATA IN WIRELESS COMMUNICATION NETWORK

(75) Inventors: Sunkyung SHIN, Daejeon (KR); Sok-kyu LEE, Daejeon (KR)

Correspondence Address: STAAS & HALSEY LLP, SUITE 700, 1201 NEW YORK AVENUE, N.W., WASHINGTON, DC, 20005, US

(73) Assignee: Electronics and Telecommunications Research Institute, Daejon (KR)

(21) Appl. No.: 12/688,368

(22) Filed: Jan. 15, 2010

(30) Foreign Application Priority Data
Jan. 16, 2009 (KR) 10-2009-0003808
Dec. 28, 2009 (KR) 10-2009-0132151

(51) Int. Cl. H04W 40/00

(52) U.S. Cl. 370/338

(57) ABSTRACT

Provided is a method and apparatus for transmitting/receiving data in a wireless communication network. The method for transmitting data from an access point to a plurality of stations in a wireless communication network includes: simultaneously transmitting request-to-send messages to the plurality of stations, the request-to-send messages having transmission order information of clear-to-send messages; receiving the clear-to-send messages transmitted from the stations according to the transmission order information; and simultaneously transmitting the data to the stations which have transmitted the clear-to-send messages.

### CROSS-REFERENCE(S) TO RELATED APPLICATIONS

The present application claims priority of Korean Patent Application Nos. 10-2009-0003808 and 10-2009-0132151 filed on Jan. 16, 2009 and Dec. 28, 2009, respectively, which are incorporated herein by reference in their entirety.

### BACKGROUND OF THE INVENTION

1. Field of the Invention

Exemplary embodiments of the present invention relate to a method and apparatus for transmitting/receiving data; and, more particularly, to a method and apparatus for transmitting/receiving data in a wireless communication network.

2. Description of Related Art

Medium Access Control (hereinafter, referred to as MAC) of a wireless LAN defined in the Institute of Electrical and Electronics Engineers (IEEE) 802.11 supports Basic Service Set (hereinafter, referred to as BSS) which is constituted by association of one Access Point (AP) and one or more stations (STA). In such a BSS environment, one access point and one station form a single channel through which data is transmitted. Meanwhile, in order to increase a data rate, studies have recently been conducted on multi-channel MAC technologies which enable the simultaneous communication between one access point and a plurality of stations.

Examples of methods which have been studied for supporting multi-channels in an ad-hoc network environment include a dedicated control channel approach, which allocates a separate channel for transmission of a control frame, a channel hopping approach, which transmits a control frame while hopping a channel on a time axis without overlapping, and a time division approach, which separates data and a control signal on a time axis and independently transmits the separated data and control signal. Since such studies which have been conducted in the ad-hoc network environment use a plurality of channels, i.e., a plurality of frequency bands, most of them are not applicable in a wireless LAN system which uses a Time Division Duplex (TDD) in a single predefined frequency band.

Examples of methods for supporting multi-channels in a BSS wireless network environment include a method of modifying a structure of a control frame, and a method of repetitively transmitting/receiving RTS/CTS as many times as the number of stations which intend to communicate with the access point.

However, the method of modifying the structure of the control frame is not compatible with the existing systems. For example, a method of adding an additional address area in order to express a plurality of transmission/reception addresses in RTS/CTS frames is not compatible with the existing systems and causes increase in the size of the control frame. A method of simultaneously transmitting a control frame using an orthogonal signal is not compatible with the existing systems and requires an additional processing in order to process the orthogonal signal. In addition, a method of repetitively using RTS/CTS as many times as the number of stations which intend to communicate with the access point degrades data transmission efficiency because a control frame transmission/reception section is lengthened with the increase in the number of the stations.

### SUMMARY OF THE INVENTION

An embodiment of the present invention is directed to a method and apparatus for transmitting/receiving data, which are compatible with an existing systems and form multi-channels, because a structure of an existing control frame is not modified.

Another embodiment of the present invention is directed to a method and apparatus for transmitting/receiving data, which are capable of improving the throughput of a system because a control frame transmission/reception section is efficiently used.

In accordance with an embodiment of the present invention, a method for transmitting data from an access point to a plurality of stations in a wireless communication network includes: simultaneously transmitting request-to-send messages to the plurality of stations, the request-to-send messages having transmission order information of clear-to-send messages; receiving the clear-to-send messages transmitted from the stations according to the transmission order information; and simultaneously transmitting the data to the stations which have transmitted the clear-to-send messages.

In accordance with another embodiment of the present invention, a method for receiving data from an access point at a station in a wireless communication network includes: receiving a request-to-send message which is transmitted from the access point after the access point applies a beamforming thereto, the request-to-send message having transmission order information of a clear-to-send message; transmitting the clear-to-send message to the access point according to the transmission order information; and receiving the data which is transmitted from the access point after the access point applies the beamforming thereto.

In accordance with another embodiment of the present invention, an apparatus for transmitting data to a plurality of stations in a wireless communication network includes: a transmission unit configured to simultaneously transmit request-to-send messages to the plurality of stations, the request-to-send messages having transmission order information of clear-to-send messages; and a reception unit configured to receive the clear-to-send messages transmitted from the stations according to the transmission order information, wherein the transmission unit simultaneously transmits the data to the stations which have transmitted the clear-to-send messages.

In accordance with another embodiment of the present invention, an apparatus for receiving data from an access point in a wireless communication network includes: a reception unit configured to receive a request-to-send message which is transmitted from the access point after the access point applies a beamforming thereto, the request-to-send message having transmission order information of a clear-to-send message; and a transmission unit configured to transmit the clear-to-send message to the access point according to the transmission order information, wherein the reception unit receives the data which is transmitted from the access point after the beamforming is applied thereto.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

### BRIEF DESCRIPTION OF THE DRAWINGS

FIG. 1 is a configuration diagram of a wireless communication network in accordance with an embodiment of the present invention.

FIG. 2 is a flowchart illustrating a method for transmitting/receiving data in accordance with an embodiment of the present invention.

FIG. 3 is a diagram explaining a method for transmitting/receiving data in accordance with another embodiment of the present invention.

FIG. 4 is a diagram illustrating a control frame structure in accordance with an embodiment of the present invention.

### DESCRIPTION OF SPECIFIC EMBODIMENTS

Exemplary embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

In transmitting/receiving data between an access point and a station in a wireless communication network, a multi-user multi-input multi-output (MIMO) system is applied for supporting multi-channels. Embodiments of the present invention are directed to a method and apparatus for simultaneously transmitting/receiving data between an access point and a station in a wireless communication network, which are compatible with an existing system because an existing control frame structure is not modified, and which are capable of improving the throughput of a system because a control frame transmission/reception section is efficiently used.

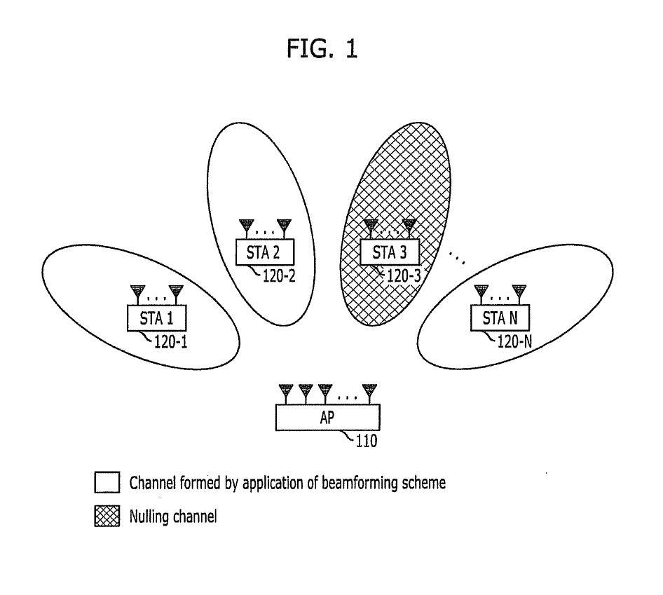

FIG. 1 is a configuration diagram of a wireless communication network in accordance with an embodiment of the present invention.

Referring to FIG. 1, the wireless communication network includes one access point (AP) 110 and one or more stations (STAs). The access point 110 performs a communication with one or more stations. The following description will be made on a case where the access point 110 transmits data to the plurality of stations 120-1 to 120-N (where N>=2). It is apparent that the present invention can also be applied to a case where the access point 110 transmits data to one station.

The access point 110 may have two or more antennas, and each of the stations 120-1 to 120-N (where N>=2) may have one or more antennas. The access point 110 must have antennas the number of which is equal to or greater than the total number of antennas of the plurality of stations 120-1 to 120-N (where N>=2) communicating with the access point 110. In FIG. 1, the antennas are illustrated in an inverted triangular shape.

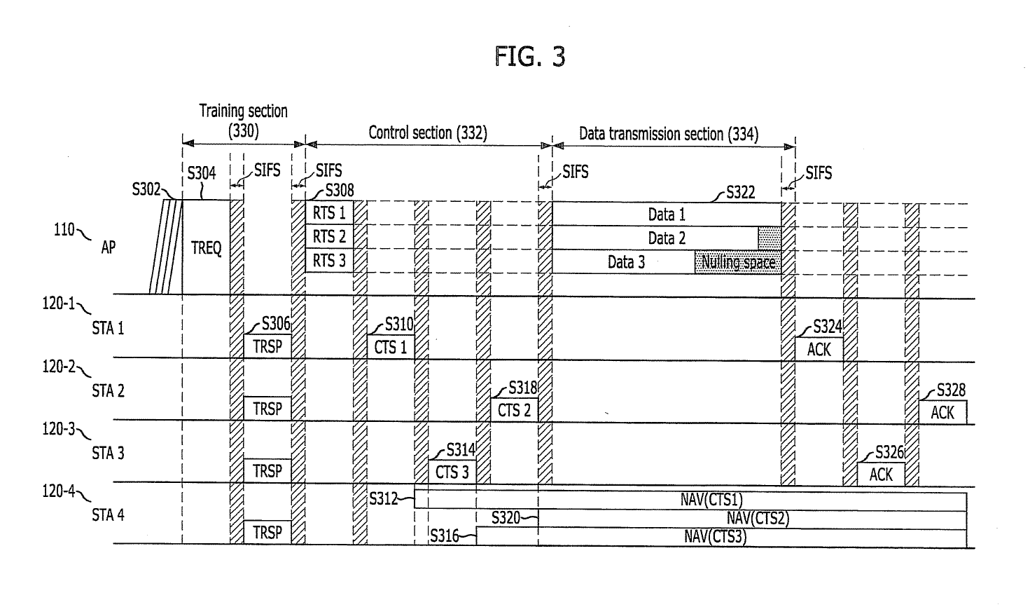

First, an apparatus for transmitting data to the plurality of stations 120-1 to 120-N (where N>=2) will be described with reference to FIG. 1. For example, the apparatus for transmitting data may be the access point 110. The access point 110 transmits/receives a predefined frame according to a MAC protocol as illustrated in FIG. 3 in order to transmit data to the plurality of stations 120-1 to 120-N (where N>=2).

A case where the access point 110 transmits the predefined frames according to the MAC protocol as illustrated in FIG. 3 will be described below. The access point 110 determines frames to be transmitted to the respective stations 120-1 to 120-N (where N>=2) according to the MAC protocol, encodes the determined frames at a physical (PHY) layer, and transmits the encoded frames through antennas. The frames refer to a data frame and a control frame which is required to control transmission of the data frame.

In this case, the access point 110 may simultaneously transmit the frames to the respective stations by allocating different antennas to the respective stations 120-1 to 120-N (where N>=2). Therefore, a data rate increases compared to a system which transmits data through a single channel formed by one access point and one station. For example, in case where each of the station 1 120-1, the station 2 120-2, and the station 4 120-4 has two antennas, respectively, the access point 110 may transmit desired frames to the station 1 120-1 through its first and second antennas, transmit desired frames to the station 2 120-2 through its third and fourth antennas, and transmit desired frames to the station 4 120-4 through its fifth and sixth antennas. In this way, the respective frames may be simultaneously transmitted to the three stations 120-1, 120-2 and 120-4.

In addition, the access point 110 may encode the determined frames, precode the encoded frames using channel information on the respective stations, and transmit the precoded frames through the antennas. When the precoding is completed, beams as illustrated in FIG. 1 are formed between the access point 110 and the respective stations. That is, the access point 110 may simultaneously transmit the corresponding frames to the respective stations, without interference, by using the independent channels formed through a beamforming scheme. No beams are formed between the access point 110 and the station to which data is not transmitted, like the station 3 120-3, and thus, no channel is formed therebetween.

A case where the access point 110 receives predefined frames according to the MAC protocol as illustrated in FIG. 3 will be described below. The frames transmitted by the respective stations 120-1 to 120-N (where N>=2) are received through the antennas of the access point 110 and then decoded. As described above, the access point 110 must have antennas the number of which is equal to or greater than the total number of antennas of the plurality of stations 120-1 to 120-N (where N>=2) communicating with the access point 110. If the access point 110 has antennas the number of which is less than the total number of antennas of the plurality of stations 120-1 to 120-N (where N>=2), the signals which are simultaneously transmitted from the plurality of stations 120-1 to 120-N (where N>=2) may not be decoded.

Next an apparatus for receiving data transmitted from the access point 110 will be described with reference to FIG. 1. The respective stations 120-1 to 120-N (where N>=2) transmit/receive predefined frames according to the MAC protocol as illustrated in FIG. 3 in order to receive data from the access point 110.

A case where the respective stations 120-1 to 120-N (where N>=2) transmit the predefined frames according to the MAC protocol as illustrated in FIG. 3 will be described below. The respective stations 120-1 to 120-N determine frames to be transmitted to the access point 110 according to the MAC protocol, encode the determined frames at a physical layer, and transmit the encoded frames through the antennas.

In addition, the respective stations 120-1 to 120-N (where N>=2) may receive the frames transmitted by the access point 110, through the antennas, and decode the frames.

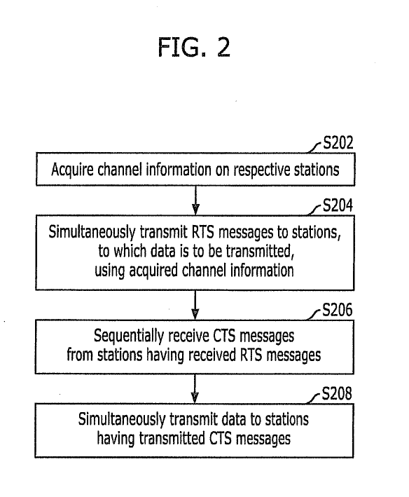

Hereinafter, a method for transmitting/receiving data in a wireless communication network in accordance with an embodiment of the present invention will be described with reference to FIGS. 2 and 3. In the embodiment which will be described below with reference to FIG. 3, the access point 110 transmits data to the three stations, i.e., the station 1 120-1, the station 2 120-2, and the station 3 120-3, in a wireless LAN system which complies with the IEEE 802.11 standard and is constituted with one access point 110 and the four stations 120-1, 120-2, 120-3 and 120-4.

At step S202, the access point 110 acquires channel information on the respective stations to which the access point intends to transmit data. As described later, the channel information is used to form beams with respect to the respective stations.

Referring to FIG. 3, as one embodiment, the access point 110 having acquired a data transmission priority through a backoff procedure S302 broadcasts a message requesting to transmit a training sequence (a training signal), to all stations associated with the access point 110, i.e., the station 1 120-1, the station 2 120-2, the station 3 120-3 and the station 4 120-4 at step S304. Hereinafter, this message will be referred to as a training request (TREQ) message.

The stations 120-1, 120-2, 120-3 and 120-4 having received the training request message at the step S304 simultaneously transmit training response (TRSP) signals, i.e., training signals, to the access point 110 after a short interframe space (SIFS) time at step S306. As described above, the access point 110 may decode the training response signals, which are simultaneously transmitted by the four stations 120-1, 120-2, 120-3 and 120-4 at the step S306, by using a decoding scheme of a multi-antenna. That is, since the access point 110 has the antennas the number of which is equal to or greater than the total number of the antennas of the four stations 120-1, 120-2, 120-3 and 120-4, the access point 110 may decode the training signals which are simultaneously transmitted by the four stations 120-1, 120-2, 120-3 and 120-4. As such, the access point 110 may estimate the channel information on the respective stations 120-1, 120-2, 120-3 and 120-4 by decoding the training signals which are simultaneously received at the step S306.

In this embodiment, in order to estimate the channel information to be used for beamforming, the training request (TREQ) message is broadcast at step S304 and the training response (TRSP) messages transmitted in response to the training request (TREQ) message at the step S306 are simultaneously received and decoded, thereby increasing the efficiency on a time axis.

At step S204, the access point 110 simultaneously transmits transmission request messages to the plurality of stations to which the access point 110 intends to transmit data. In this case, the access point 110 may simultaneously transmit the transmission request messages by forming beams on the basis of the channel information on the respective stations, which is acquired at the step S202. The transmission request message is a message informing that the access point 110 is ready to transmit data, and functions to reserve a channel for data transmission.

Referring to FIG. 3, as one embodiment, the transmission request message may be a request-to-send (RTS) message. The access point 110 simultaneously transmits an RTS message RTS1, an RTS message RTS2, and an RTS message RTS3, respectively, to the station 1 120-1, the station 2 120-2, and the station 3 120-3 at step S308.

At this time, the access point 110 may simultaneously transmit the respective RTS messages RTS1, RTS2 and RTS3 by forming the independent beams with respect to the stations 120-1, 120-2 and 120-3 on the basis of the channel information on the respective stations 120-1, 120-2 and 120-3, which is estimated from the training response (TRSP) signals received at the step S306. No beam is formed at the station 4 120-4 to which the RTS message is not transmitted, and thus, a nulling channel is formed.

In addition, at the step S308 the access point 110 may set clear-to-send (CTS) message transmission order information within the RTS messages RTS1, RTS2 and RTS3. The CTS message transmission order information refers to information on order in which the respective stations 120-1, 120-2 and 120-3 transmit clear-to-send (CTS) messages CTS1, CTS2 and CTS3, which are the response messages with respect to the RTS messages after the respective stations 120-1, 120-2 and 120-3 receive the RTS messages RTS1, RTS2 and RTS3. For example, the access point 110 may set the CTS message transmission order (1) of the station 1 120-1 in the RTS message RTS1, the CTS message transmission order (3) of the station 2 120-2 in the RTS message RTS2, and the CTS message transmission order (2) of the station 3 120-3 in the RTS message RTS3, and simultaneously transmit the RTS messages RTS1, RTS2 and RTS3 at the step S308.

At step S206, the access point 110 sequentially receives transmission approval messages from one or more stations having received the transmission request messages transmitted at the step S204. The transmission approval message is a response to the transmission request message, and is a message informing that the station is ready to receive data.

Referring to FIG. 3, as one embodiment, the transmission approval message may be a clear-to-send (CTS) message. The respective stations 120-1, 120-2 and 120-3 having received the RTS messages RTS1, RTS2 and RTS3 may simultaneously transmit the CTS messages CTS1, CTS2 and CTS3 to the access point 110, but may also sequentially transmit the CTS messages CTS1, CTS2 and CTS3 to the access point 110, without using the beamforming scheme. At steps S310, S314 and S318, the respective stations 120-1, 120-2 and 120-3 transmit the CTS messages CTS1, CTS2 and CTS3 according to the CTS message transmission order information set in the respective RTS messages RTS1, RTS2 and RTS3. For example, as illustrated in FIG. 3, the station 1 120-1 transmits the CTS message CTS1 at S310, the station 3 120-3 transmits the CTS message CTS3 at step S314, and the last station 2 120-2 transmits the CTS message CTS2 at step S318.

The sequential transmission of the CTS messages CTS1, CTS2 and CTS3 without using the beamforming scheme is done so that the station 4 120-4 which does not participate in the data transmission/reception can receive the CTS messages CTS1, CTS2 and CTS3 and update a network allocation vector (NAV). The network allocation vector informs that the access point 110 or other station has an access authority with respect to the medium during a set time period.

In the example of FIG. 3, since the station 4 120-4 can receive the CTS message CTS1 transmitted by the station 1 120-1 at the step S310, the station 4 120-4 receives the CTS message CTS1 at the step S310 and then sets the network allocation vector NAV(CTS1) at step S312. In such a manner, after receiving the CTS message CTS3 at the step S314, the station 4 120-4 sets the network allocation vector NAV(CTS3) at step S316. After receiving the CTS message CTS2 at the step S318, the station 4 120-4 sets the network allocation vector NAV(CTS2) at step S320. Thus, the station 4 120-4 does not check the use/non-use of the medium until the value of the network allocation vector becomes zero. Therefore, the access point 110 may avoid collision during a period where it transmits data to the respective stations 120-1, 120-2 and 120-3.

The access point 110 sequentially receives the transmission approval messages at the step S206 and then simultaneously transmits data to the stations which have transmitted the transmission approval messages at step S208.

Referring to FIG. 3, as one embodiment, when the access point 110 receives the CTS messages CTS1, CTS2 and CTS3 from the respective stations 120-1, 120-2 and 120-3, the access point 110 simultaneously transmits data Data1, Data2 and Data3 to the respective stations 120-1, 120-2 and 120-3 during a preset data transmission section 334 at step S322. In accordance with the embodiment of FIG. 3, the access point 110 may simultaneously transmit the data 1 Data1 to the station 1 120-1, the data 2 Data2 to the station 2 120-2, and the data 3 Data3 to the station 3 120-3.

At the step S322, the access point 110 may simultaneously transmit the data Data1, Data2 and Data3 to the respective stations 120-1, 120-2 and 120-3 by forming the beams on the basis of the channel information on the respective stations 120-1, 120-2 and 120-3, which is acquired at the step S306.

The data transmission section 334 may be preset according to a protocol, and may be set while the access point 110 and the stations 120-1, 120-2 and 120-3 transmit/receive control frames during a control section 332. Since the respective data Data1, Data2 and Data 3 may have different sizes, the access point 110 may transmit data while containing null data in the data Data2 and Data3 having a smaller size than the data transmission section 334 in order to match the data transmission section 334. As another embodiment, the stations 120-2 and 120-3 receiving data having a smaller size than the data transmission section 334 from the access point 110 may wait until the data transmission section 334 is completed, and perform subsequent procedures S324, S326 and S328.

When the data transmission section 334 is completed, the stations 120-1, 120-2 and 120-3 receiving the respective data Data1, Data2 and Data3 perform a data reception confirmation procedure after the SIFS time. As one embodiment, the respective stations 120-1, 120-2 and 120-3 receiving the respective data Data1, Data2 and Data3 may transmit a reception acknowledge (ACK) message according to the CTS transmission order information. That is, when the data transmission section 334 is completed, the station 1 120-1 transmits the reception acknowledge message to the access point 110 after the SIFS time at step S324. After elapse of the SIFS time from the transmission of the reception acknowledge message from the station 1 120-1 at the step S324, the station 3 120-3 transmits the reception acknowledge message to the access point 110 at step S326. After elapse of another SIFS time, the station 2 120-2 transmits the reception acknowledge message to the access point 110 at step S328. As another embodiment, after elapse of the SIFS time from the completion of the data transmission section 334, the respective stations 120-1, 120-2 and 120-3 may simultaneously transmit the reception acknowledge messages to the access point 110.

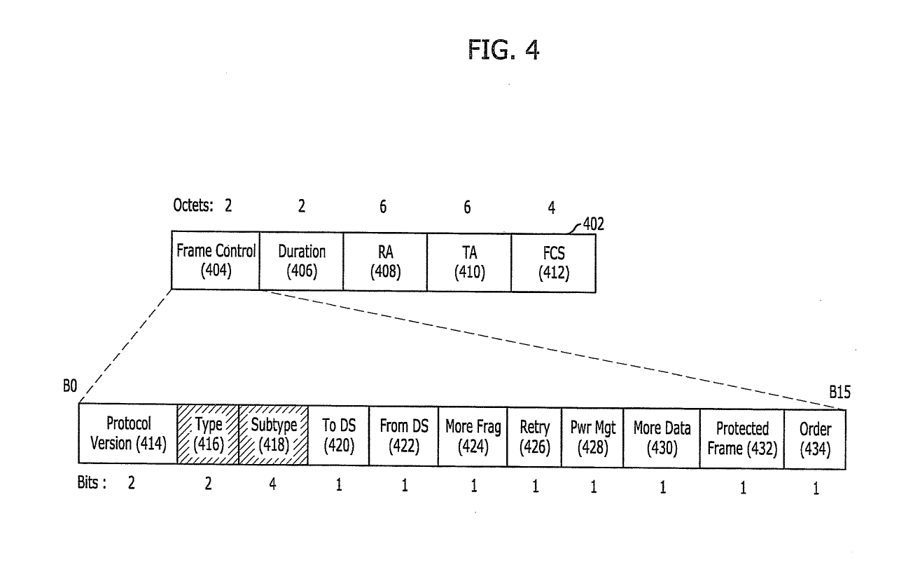

FIG. 4 is illustrates the structure of a control frame in accordance with an embodiment of the present invention. Referring to FIG. 4, an RTS frame 402 defined in the IEEE 802.11 standard is composed of 10 octets, and includes a Frame-Control field 404, a Duration field 406, a Receiver-Address (RA) field 408, a Transmitter-Address (TA) field 410, and a Frame-Check-Sequence (FCS) field 412.

The Frame-Control field 404 used to control the frame includes a Protocol-Version subfield 414, a Type subfield 416, a Subtype subfield 418, a To-Distribution-Service (ToDS) subfield 420, a From-Distribution-Service (FromDS) subfield 422, a More-Fragment (More Frag) subfield 424, a Retry subfield 426, a Power-Management (Pwr Mgt) subfield 428, a More-Data subfield 430, a Protected-Frame subfield 432, and an Order subfield 434.

According to the IEEE 802.11 standard, as can be seen from Table 1 below, the Type subfield 416 ‘11’ and some values of the Subtype subfield 418 are not defined. Therefore, in this embodiment, the CTS message transmission order information is set using the undefined values of the Type subfield 416 and the Subtype subfield 418. For example, in the RTS message RTS1 to be transmitted to the station 1 120-1, the Type subfield 416 and the Subtype subfield 418 may be set to ‘11’ and ‘0001’, respectively.

In the same manner, in the RTS message RTS2 to be transmitted to the station 2 120-2, the Type subfield 416 and the Subtype subfield 418 may be set to ‘11’ and ‘0003’, respectively. In the RTS message RTS3 to be transmitted to the station 3 120-3, the Type subfield 416 and the Subtype subfield 418 may be set to ‘11’ and 0002′, respectively.

TABLE 1

| Type value | Type | Subtype value | Subtype |
|---|---|---|---|
| b3 b2 | description | b7 b6 b5 b4 | Description |
| 00 | Management | 0000 | Association |
| | | | request |
| . . . | . . . | . . . | . . . |
| 01 | Control | 0000-1111 | Reserved |
| . . . | . . . | . . . | . . . |
| 10 | Data | 0000 | Data |
| . . . | . . . | . . . | . . . |
| 11 | Reserved | 0000-1111 | Reserved |

Although the methods for transmitting/receiving data in the wireless LAN system which complies with the IEEE 802.11 standard and is constituted with one access and four stations have been described above, it is apparent that the embodiments of the present invention can also be applied to any type of wireless communication networks which perform the control frame transmission for the purpose of data transmission/reception.

Since the method and apparatus in accordance with the exemplary embodiments of the present invention do not modify the existing control frame structure, they are compatible with the existing systems and may simultaneously transmit/receive data between the single access point and the plurality of stations.

Moreover, the throughput of the system may be improved through the efficient use of the control frame transmission/reception section.

The above-described methods can also be embodied as computer programs. Codes and code segments, constituting the programs may be easily construed by computer programmers skilled in the art to which the invention pertains. Furthermore, the created programs may be stored in computer-readable recording media or data storage media and may be read out and executed by the computers. Examples of the computer-readable recording media include any computer-readable recoding media, e.g., intangible media such as carrier waves, as well as tangible media such as CD or DVD.

While the present invention has been described with respect to the specific embodiments, it will be apparent to those skilled in the art that various changes and modifications may be made without departing from the spirit and scope of the invention as defined in the following claims.

What is claimed is:

1. A method for transmitting data from an access point to a plurality of stations in a wireless communication network, the method comprising:
simultaneously transmitting request-to-send messages to the plurality of stations, the request-to-send messages having transmission order information of clear-to-send messages;
receiving the clear-to-send messages transmitted from the stations according to the transmission order information; and
simultaneously transmitting the data to the stations which have transmitted the clear-to-send messages.

2. The method of claim 1, further comprising:
broadcasting a request message requesting training signals;
simultaneously receiving the training signals transmitted from the stations in response to the request message; and
acquiring channel information by decoding the simultaneously received training signals,
wherein, the request-to-send messages or the data is simultaneously transmitted to the stations by forming beams on the basis of the channel information.

3. The method of claim 1, wherein the request-to-send message comprises a Type subfield of a Frame-Control field set to ‘11’ and a Subtype subfield of the Frame-Control field set to the transmission order information of the clear-to-send message.

4. The method of claim 1, wherein the data comprises null data for adjusting a transmission section.

5. The method of claim 1, further comprising setting a network allocation vector by the other stations inside the wireless communication network, the other stations having received the clear-to-send messages transmitted from the plurality of stations according to the transmission order information.

6. The method of claim 1, further comprising receiving reception acknowledge messages which are transmitted according to the transmission order information by the stations receiving the data.

7. A method for receiving data from an access point at a station in a wireless communication network, the method comprising:
receiving a request-to-send message which is transmitted from the access point after the access point applies a beamforming thereto, the request-to-send message having transmission order information of a clear-to-send message;
transmitting the clear-to-send message to the access point according to the transmission order information; and
receiving the data which is transmitted from the access point after the access point applies the beamforming thereto.

8. The method of claim 7, further comprising:
receiving a request message requesting a training signal, the request message being broadcast by the access point; and
transmitting the training signal to the access point,
wherein the beamforming is performed using channel information acquired by decoding the training signal at the access point.

9. The method of claim 7, wherein the request-to-send message comprises a Type subfield of a Frame-Control field set to ‘11’ and a Subtype subfield of the Frame-Control field set to the transmission order information of the clear-to-send message.

10. The method of claim 7, further comprising transmitting a reception acknowledge message to the access point in response to the data reception according to the transmission order information.

11. An apparatus for transmitting data to a plurality of stations in a wireless communication network, the apparatus comprising:
a transmission unit configured to simultaneously transmit request-to-send messages to the plurality of stations, the request-to-send messages having transmission order information of clear-to-send messages; and
a reception unit configured to receive the clear-to-send messages transmitted from the stations according to the transmission order information,
wherein the transmission unit simultaneously transmits the data to the stations which have transmitted the clear-to-send messages.

12. The apparatus of claim 11, wherein:
the reception unit is configured to simultaneously receive training signals transmitted from the stations; and
the transmission unit is configured to broadcast a request message requesting the stations to transmit the training signals, and to simultaneously transmit the request-to-send messages or the data to the stations by forming beams on the basis of channel information acquired by decoding the simultaneously received training signals.

13. The apparatus of claim 11, wherein the request-to-send message comprises a Type subfield of a Frame-Control field set to ‘11’ and a Subtype subfield of the Frame-Control field set to the transmission order information of the clear-to-send message.

14. An apparatus for receiving data from an access point in a wireless communication network, the apparatus comprising:
a reception unit configured to receive a request-to-send message which is transmitted from the access point after the access point applies a beamforming thereto, the request-to-send message having transmission order information of a clear-to-send message; and
a transmission unit configured to transmit the clear-to-send message to the access point according to the transmission order information,
wherein the reception unit receives the data which is transmitted from the access point after the beamforming is applied thereto.

15. The apparatus of claim 14, wherein:
the reception unit is configured to receive a request message requesting a training signal, the request message being broadcast by the access point;
the transmission unit is configured to transmit the training signal to the access point; and
the beamforming is performed using channel information acquired by decoding the training signal at the access point.

16. The apparatus of claim 14, where in the request-to-send message comprises a Type subfield of a Frame-Control field set to ‘11’ and a Subtype subfield of the Frame-Control field set to the transmission order information of the clear-to-send message.
